(19) United States
(12) Patent Application Publication
(10) Pub. No.: US 2020/0133053 A1
(43) Pub. Date: Apr. 30, 2020

(54) COLOR FILTER SUBSTRATE AND LIQUID CRYSTAL DISPLAY DEVICE

(71) Applicant: Wuhan China Star Opoelectronics Technology Co., LTD., Wuhan, Hubei (CN)

(72) Inventors: Chaoqun YANG, Wuhan, Hubei (CN); Changchih Huang, Wuhan, Hubei (CN)

(21) Appl. No.: 16/335,253

(22) PCT Filed: Nov. 19, 2018
(86) PCT No.: PCT/CN2018/116283

§ 371 Date: Mar. 21, 2019

(30) Foreign Application Priority Data
Oct. 25, 2018 (CN) 201811253620.0

(51) Int. Cl. G02F 1/1335; G02F 1/13357

(52) U.S. Cl. CPC G02F 1/133514; G02F 1/133512; G02F 1/133553; G02F 1/133617; G02F 2001/133567; G02F 2202/36; G02F 2001/133614; G02F 2201/50; G02F 2001/133565; G02F 1/133528

(57) ABSTRACT

Provided are a color filter substrate and a liquid crystal display device. The color filter substrate includes a base substrate, a plurality of quantum dot filter units arranged in an array on the base substrate and retaining walls disposed among the quantum dot filter units on the base substrate; the retaining wall includes a black matrix layer disposed on the base substrate and a reflective layer disposed on the black matrix layer, and the retaining wall has a thickness greater than a thickness of the quantum dot filter unit. The reflective layer can re-reflect light irradiated on a surface thereof to the quantum dot filter units for secondary utilization, thereby improving utilization of the light while avoiding color mixture through the other quantum dot filter units.

### FIELD OF THE INVENTION

The present invention relates to a display field, and more particularly to a color filter substrate and a liquid crystal display device.

### BACKGROUND OF THE INVENTION

The Liquid Crystal Display (LCD) possesses advantages of thin body, power saving and no radiation to be widely used in many application scope. Such as LCD TV, mobile phone, personal digital assistant (PDA), digital camera, notebook, laptop, and dominates the flat panel display field.

The working principle of the liquid crystal display is that liquid crystal molecules are injected between the Thin Film Transistor Array Substrate (TFT array substrate) and the Color Filter (CF) substrate. The light of backlight module is refracted to generate images by applying driving voltages to the two substrates for controlling the rotations of the liquid crystal molecules.

The colors of the liquid crystal display are realized by color filters (CF). The conventional color filters include red, green and blue photoresists arranged in a certain order. When the light emitted from the backlight passes through the red, green and blue photoresists, only the light corresponding to the red, green and blue bands can be transmitted to convert the light emitted by the backlight into red light, green light and blue light of three colors. However, the conventional color filters have poor utilization of light, low transmittance. The transmission peak of the conventional color resist material is wide and the color density is limited. Thus, it is difficult to realize the disadvantage of wide color gamut, which cannot satisfy the requirements of the users for image displaying quality.

Quantum Dots (QDs) are spherical semiconductor nanoparticles composed of II-VI or III-V elements with a particle size generally ranging from a few nanometers to tens of nanometers. Due to the existence of the quantum confinement effect of the quantum dot material, the original continuous energy level structure becomes a discrete energy level structure and can emit visible light as being excited by the outside. Quantum dot material possesses a small half-height width and a luminescent color can be easily adjusted by the size, structure or composition of the quantum dot material. Therefore, it is applied to a display device to replace the existing red photoresist and green photoresist and blue photoresist. Other structures will continue to follow the technical process of the conventional liquid crystal display device, and respective quantum dot filter units are separated by a black matrix to ensure that color mixture does not occur between different colors. However, the film thickness of the current quantum filter unit is generally 3 μm to 6 μm, and the current technical black matrix cannot achieve a scale of 2 μm or more, so it is difficult to separate different quantum filter units by relying on one single layer of black matrix. It is prone to color mixture, resulting in poor display.

### SUMMARY OF THE INVENTION

An objective of the present invention is to provide a color filter substrate, which can effectively separate respective quantum dot filter units to improve light utilization while avoiding color mixture.

Another objective of the present invention is to provide a liquid crystal display device, which can effectively separate respective quantum dot filter units to improve light utilization while avoiding color mixture.

For realizing the aforesaid objectives, the present invention provides a color filter substrate, including a base substrate, a plurality of quantum dot filter units arranged in an array on the base substrate and retaining walls disposed among the quantum dot filter units on the base substrate;

wherein the retaining wall includes a black matrix layer disposed on the base substrate and a reflective layer disposed on the black matrix layer, and the retaining wall has a thickness greater than a thickness of the quantum dot filter unit.

A reflectivity of the reflective layer is greater than 70%;

the reflective layer has a thickness of 3 μm to 6 μm, and an optical density value of the reflective layer per one micrometer thickness is greater than 1.

The color filter substrate further includes a protective layer on the quantum dot filter units and on the retaining walls, and a water-oxygen barrier layer between the quantum dot filter units and the protective layer.

The plurality of quantum dot filter units include red quantum dot filter units, green quantum dot filter units and blue quantum dot filter units that are alternately arranged in sequence.

wherein a blue filter layer is further disposed between the red quantum dot filter unit and the base substrate and between the green quantum dot filter unit and the base substrate.

The present invention further provides a liquid crystal display device, including a backlight module and a liquid crystal display panel disposed above the backlight module;

wherein the liquid crystal display panel includes: a color filter substrate, a counter substrate disposed opposite to the color filter substrate and a liquid crystal layer between the color filter substrate and the counter substrate; the backlight module is located on a side of the counter substrate away from the color filter substrate;

wherein the color filter substrate includes a first base substrate, a plurality of quantum dot filter units arranged in an array on the first base substrate and retaining walls disposed among the quantum dot filter units on the first base substrate;

wherein the retaining wall includes a black matrix layer disposed on the first base substrate and a reflective layer disposed on the black matrix layer, and the retaining wall has a thickness greater than a thickness of the quantum dot filter unit.

A reflectivity of the reflective layer is greater than 70%;

the reflective layer has a thickness of 3 μm to 6 μm, and an optical density value of the reflective layer of per 1 μm thickness is greater than 1.

The color filter substrate further includes a protective layer on the quantum dot filter units and on the retaining walls, and a water-oxygen barrier layer between the quantum dot filter units and the protective layer.

The plurality of quantum dot filter units include red quantum dot filter units, green quantum dot filter units and blue quantum dot filter units that are alternately arranged in sequence;

wherein a blue filter layer is further disposed between the red quantum dot filter unit and the base substrate and between the green quantum dot filter unit and the base substrate.

The liquid crystal display device further includes a first polarizing layer and a second polarizing layer;

wherein the first polarizing layer is located between the counter substrate and the backlight module, and the second polarizing layer is located between the color filter substrate and the liquid crystal layer.

The benefits of the present invention are: the present invention provides a color filter substrate. The color filter substrate includes a base substrate, a plurality of quantum dot filter units arranged in an array on the base substrate and retaining walls disposed among the quantum dot filter units on the base substrate; the retaining wall includes a black matrix layer disposed on the base substrate and a reflective layer disposed on the black matrix layer, and the retaining wall has a thickness greater than a thickness of the quantum dot filter unit. The reflective layer can re-reflect light irradiated on a surface thereof to the quantum dot filter units for secondary utilization, thereby improving utilization of the light while avoiding color mixture through the other quantum dot filter units. The present invention further provides a liquid crystal display device, which can effectively separate respective quantum dot filter units to improve light utilization while avoiding color mixture.

### BRIEF DESCRIPTION OF THE DRAWINGS

In order to better understand the characteristics and technical aspect of the invention, please refer to the following detailed description and accompanying drawings of the present invention. However, the drawings are provided for reference only and are not intended to be limiting of the invention.

In drawings,

FIG. 1 is a structural diagram of a color filter substrate of the present invention;

FIG. 2 is a structural diagram of a liquid crystal display device of the present invention.

### DETAILED DESCRIPTION OF PREFERRED EMBODIMENTS

For better explaining the technical solution and the effect of the present invention, the present invention will be further described in detail with the accompanying drawings and the specific embodiments.

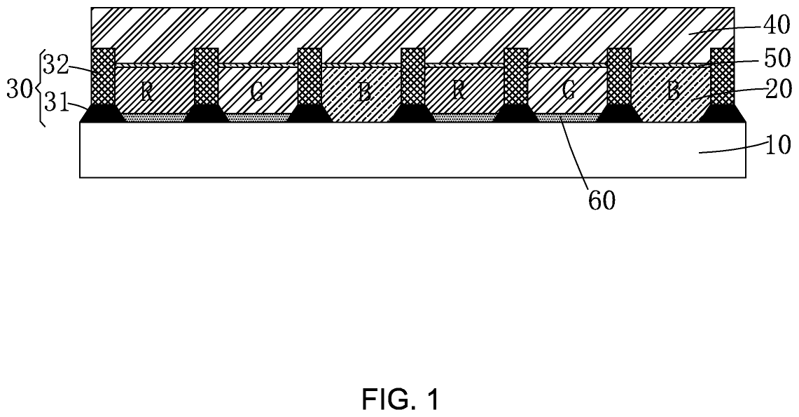

Please refer to FIG. 1. The present invention provides a color filter substrate, including a base substrate 10, a plurality of quantum dot filter units 20 arranged in an array on the base substrate 10 and retaining walls 30 disposed among the quantum dot filter units 20 on the base substrate 10;

The retaining wall 30 includes a black matrix layer 31 disposed on the base substrate 10 and a reflective layer 32 disposed on the black matrix layer 31, and the retaining wall 30 has a thickness greater than a thickness of the quantum dot filter unit 20.

Specifically, by separating the respective quantum dot filter units 20 with forming the retaining walls 30 by superimposing the reflective layers 32 on the black matrix layers 31, the thickness of the black matrix layer 31 can be compensated for, such that the thickness of the retaining wall 30 is greater than the thickness of the quantum dot filter unit 20. Meanwhile, by the arrangement of the reflective layer 32, the light irradiated on the surface thereof can be re-reflected into the quantum dot filter unit 20 for secondary utilization to improve the utilization of the light, wherein the light irradiated on the surface of the reflective layer 32 includes light excited by the quantum dot filter units 20 and incident backlight. Furthermore, the reflective layer 32 is also capable of blocking the light irradiated on the surface thereof from entering the other quantum dot filter units 20, thereby avoiding color mixture and ensuring display effects.

For ensuring the reflection and light blocking effects of the reflective layer 32, the reflectivity of the reflective layer 32 in the present invention is greater than 70%, and the reflective layer has a thickness of 3 μm to 6 μm, and an optical density value of the reflective layer 32 of per 1 μm thickness is greater than 1. Thus, it can be ensured that most of the light irradiated on the surface of the reflective layer 32 is reflected back into the quantum dot filter units 20, and the remaining portion of the light is absorbed by the reflective layer 32, thereby effectively preventing the light from passing through the quantum dot filter units 20, resulting in color mixture or color shift.

Specifically, the color filter substrate further includes a protective layer 40 on the quantum dot filter units 20 and on the retaining walls 30, and a water-oxygen barrier layer 50 between the quantum dot filter units 20 and the protective layer 40. The water-oxygen barrier layer 50 serves to prevent the quantum dot filter units 20 from being infiltrated by water and oxygen, resulting in device failure.

Specifically, the plurality of quantum dot filter units 20 include red quantum dot filter units R, green quantum dot filter units G and blue quantum dot filter units B that are alternately arranged in sequence. A blue filter layer 60 is further disposed between the red quantum dot filter unit R and the base substrate 10 and between the green quantum dot filter unit G and the base substrate 10. The red quantum dot filter unit R, the green quantum dot filter unit G and the blue quantum dot filter unit B are respectively used to generate red light, green light and blue light under excitation of the incident backlight. The blue filter layer 60 is used for further filtering the red light and the green light to remove blue light components therein and to improve color purity.

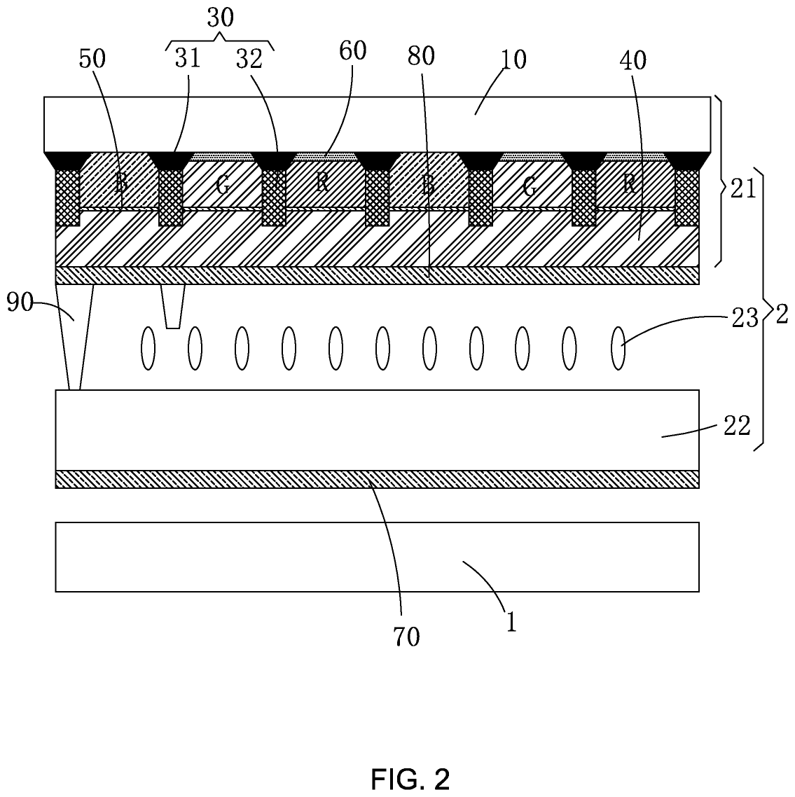

Please refer to FIG. 2. The present invention further provides a liquid crystal display device, including a backlight module 1 and a liquid crystal display panel 2 disposed above the backlight module 1;

wherein the liquid crystal display panel 2 includes: a color filter substrate 21, a counter substrate 22 disposed opposite to the color filter substrate 21 and a liquid crystal layer 23 between the color filter substrate 21 and the counter substrate 22; the backlight module 1 is located on a side of the counter substrate 22 away from the color filter substrate 21;

wherein the color filter substrate 21 includes a first base substrate 10, a plurality of quantum dot filter units 20 arranged in an array on the first base substrate 10 and retaining walls 30 disposed among the quantum dot filter units 20 on the first base substrate 10;

The retaining wall 30 includes a black matrix layer 31 disposed on the first base substrate 10 and a reflective layer 32 disposed on the black matrix layer 31, and the retaining wall 30 has a thickness greater than a thickness of the quantum dot filter unit 20.

Specifically, by separating the respective quantum dot filter units 20 with forming the retaining walls 30 by superimposing the reflective layers 32 on the black matrix layers 31, the thickness of the black matrix layer 31 can be compensated for, such that the thickness of the retaining wall 30 is greater than the thickness of the quantum dot filter unit 20. Meanwhile, by the arrangement of the reflective layer 32, the light irradiated on the surface thereof can be re-reflected into the quantum dot filter unit 20 for secondary utilization to improve the utilization of the light, wherein the light irradiated on the surface of the reflective layer 32 includes light excited by the quantum dot filter units 20 and incident backlight. Furthermore, the reflective layer 32 is also capable of blocking the light irradiated on the surface thereof from entering the other quantum dot filter units 20, thereby avoiding color mixture and ensuring display effects.

For ensuring the reflection and light blocking effects of the reflective layer 32, the reflectivity of the reflective layer 32 in the present invention is greater than 70%, and the reflective layer has a thickness of 3 μm to 6 μm, and an optical density value of the reflective layer 32 of per 1 μm thickness is greater than 1. Thus, it can be ensured that most of the light irradiated on the surface of the reflective layer 32 is reflected back into the quantum dot filter units 20, and the remaining portion of the light is absorbed by the reflective layer 32, thereby effectively preventing the light from passing through the quantum dot filter units 20, resulting in color mixture or color shift.

Specifically, the color filter substrate further includes a protective layer 40 on the quantum dot filter units 20 and on the retaining walls 30, and a water-oxygen barrier layer 50 between the quantum dot filter units 20 and the protective layer 40. The water-oxygen barrier layer 50 serves to prevent the quantum dot filter units 20 from being infiltrated by water and oxygen, resulting in device failure.

Specifically, the plurality of quantum dot filter units 20 include red quantum dot filter units R, green quantum dot filter units G and blue quantum dot filter units B that are alternately arranged in sequence. A blue filter layer 60 is further disposed between the red quantum dot filter unit R and the base substrate 10 and between the green quantum dot filter unit G and the base substrate 10. The red quantum dot filter unit R, the green quantum dot filter unit G and the blue quantum dot filter unit B are respectively used to generate red light, green light and blue light under excitation of the incident backlight. The blue filter layer 60 is used for further filtering the red light and the green light to remove blue light components therein and to improve color purity.

Specifically, the counter substrate 22 is an array substrate on which a thin film transistor array is formed.

Specifically, spacers 90 for supporting a gap between the counter substrate 22 and the color filter substrate 21 are further formed between the counter substrate 22 and the color filter substrate 21. The spacers 90 include a primary spacer and a sub spacer having a height less than the main spacer, and the spacers 90 are located above areas in which the retaining walls 30 are located.

Specifically, since the light generated by the quantum dot filter unit 20 is unpolarized light, the present invention adjusts the position of the polarizer of the liquid crystal display device. Specifically, the liquid crystal display device further includes a first polarizing layer 70 and a second polarizing layer 80; the first polarizing layer 70 is located between the counter substrate 22 and the backlight module 1, and the second polarizing layer 80 is located between the color filter substrate 21 and the liquid crystal layer 23. By placing the second polarizing layer 80 between the color filter substrate 21 and the liquid crystal layer 23, the problem that the light generated by the quantum dot filter unit 20 is unpolarized light and cannot be emitted from the polarizing layer can be avoided.

Specifically, the polarization axes of the first polarizing layer 70 and the second polarizing layer 80 are perpendicular.

Preferably, the second polarizing layer 80 is a metal grating polarizing layer.

In conclusion, the present invention provides a color filter substrate. The color filter substrate includes a base substrate, a plurality of quantum dot filter units arranged in an array on the base substrate and retaining walls disposed among the quantum dot filter units on the base substrate; the retaining wall includes a black matrix layer disposed on the base substrate and a reflective layer disposed on the black matrix layer, and the retaining wall has a thickness greater than a thickness of the quantum dot filter unit. The reflective layer can re-reflect light irradiated on a surface thereof to the quantum dot filter units for secondary utilization, thereby improving utilization of the light while avoiding color mixture through the other quantum dot filter units. The present invention further provides a liquid crystal display device, which can effectively separate respective quantum dot filter units to improve light utilization while avoiding color mixture.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A color filter substrate, including a base substrate, a plurality of quantum dot filter units arranged in an array on the base substrate and retaining walls disposed among the quantum dot filter units on the base substrate;
wherein the retaining wall includes a black matrix layer disposed on the base substrate and a reflective layer disposed on the black matrix layer, and the retaining wall has a thickness greater than a thickness of the quantum dot filter unit.

2. The color filter substrate according to claim 1, wherein a reflectivity of the reflective layer is greater than 70%;
the reflective layer has a thickness of 3 μm to 6 μm, and an optical density value of the reflective layer per one micrometer thickness is greater than 1.

3. The color filter substrate according to claim 1, further including a protective layer on the quantum dot filter units and on the retaining walls, and a water-oxygen barrier layer between the quantum dot filter units and the protective layer.

4. The color filter substrate according to claim 1, wherein the plurality of quantum dot filter units include red quantum dot filter units, green quantum dot filter units and blue quantum dot filter units that are alternately arranged in sequence.

5. The color filter substrate according to claim 1, wherein a blue filter layer is further disposed between the red quantum dot filter unit and the base substrate and between the green quantum dot filter unit and the base substrate.

6. A liquid crystal display device, including a backlight module and a liquid crystal display panel disposed above the backlight module;
wherein the liquid crystal display panel includes: a color filter substrate, a counter substrate disposed opposite to the color filter substrate and a liquid crystal layer between the color filter substrate and the counter substrate; the backlight module is located on a side of the counter substrate away from the color filter substrate;
wherein the color filter substrate includes a first base substrate, a plurality of quantum dot filter units arranged in an array on the first base substrate and retaining walls disposed among the quantum dot filter units on the first base substrate;
wherein the retaining wall includes a black matrix layer disposed on the first base substrate and a reflective layer disposed on the black matrix layer, and the retaining wall has a thickness greater than a thickness of the quantum dot filter unit.

7. The liquid crystal display device according to claim 6, wherein a reflectivity of the reflective layer is greater than 70%;
the reflective layer has a thickness of 3 μm to 6 μm, and an optical density value of the reflective layer per one micrometer thickness is greater than 1.

8. The liquid crystal display device according to claim 6, wherein the color filter substrate further includes a protective layer on the quantum dot filter units and on the retaining walls, and a water-oxygen barrier layer between the quantum dot filter units and the protective layer.

9. The liquid crystal display device according to claim 6, wherein the plurality of quantum dot filter units include red quantum dot filter units, green quantum dot filter units and blue quantum dot filter units that are alternately arranged in sequence;
wherein a blue filter layer is further disposed between the red quantum dot filter unit and the base substrate and between the green quantum dot filter unit and the base substrate.

10. The liquid crystal display device according to claim 6, further including a first polarizing layer and a second polarizing layer;
wherein the first polarizing layer is located between the counter substrate and the backlight module, and the second polarizing layer is located between the color filter substrate and the liquid crystal layer.
